(19) United States
(12) Patent Application Publication
(10) Pub. No.: US 2004/0161592 A1
(43) Pub. Date: Aug. 19, 2004

(54) Reproducible information holding medium, reproducing method of the information holding medium and reproducing apparatus

(76) Inventors: Masazumi Yoshida, Amagasaki-Shi (JP); Takamasa Ueda, Osaka (JP); Katsuhiko Asai, Osaka (JP)

Correspondence Address: MCDERMOTT WILL & EMERY LLP, 600 13TH STREET, N.W., WASHINGTON, DC, 20005-3096, US

(21) Appl. No.: 10/368,009

(22) Filed: Feb. 19, 2003

(51) Int. Cl. B32B 9/04

(52) U.S. Cl. 428/202; 428/195.1; 428/500; 428/532

(57) ABSTRACT

In order to provide a reproducible information holding medium which is capable of being easily removed in a state that a printing label layer does not remain on a substrate, a reproducing method thereof and a reproducing apparatus, a card 10A is constituted so that an adhesive label 16 to be a signature section is laminated onto a substrate 12 as an IC card. A water growth layer 14 is provided between the adhesive label 16 and the substrate 12. The water growth layer 14 is fixed onto the substrate 12 by an intermediate adhesive layer 19. Water is supplied to the adhesive label 16 so that the water growth layer 14 swells and the adhesion of the adhesive label 16 is weakened. The adhesive label 16 can be peeled easily. A new adhesive label is laminated to the water growth layer from which the adhesive label 16 is peeled, so that the card 10A is reproduced.

This application is based on Application No. JP 2002-39486 filed in Japan, the entire content of which is hereby incorporated by reference.

### BACKGROUND OF THE INVENTION

1. Field of the Invention

The present invention relates to an improved information holding medium. Specifically, the invention relates to the information holding medium which has a printable label layer and is capable of holding information by printing on at least the label layer. More concretely, the reproducible information holding medium having the above structure, a reproducing method of the information holding medium and a reproducing apparatus.

2. Description of the Related Art

Conventionally, various cards such as a credit card, a point card, an ID card are widely used. Such cards normally have a magnetic recording section, a thermal recording section and the like in themselves, and information is held in these recording sections. Moreover, a printing label layer for signature is laminated to a part of a card, and printing is carried out on this label layer, thereby holding information.

Recently, a so-called IC card, which contains a semiconductor circuit such as an antenna, a storage circuit and a computing circuit, starts to spread. A signature section where a user signs is provided onto such an IC card.

A label to be the signature section is adhered onto a card so as not to be peeled when it is used. Normally, the label is strongly adhered to the card, and it is very difficult to peel it from the card. When the label is tried to be forcibly peeled, a surface layer of the label is broken and a part of it as well as a cohesive layer remains on the card or in the case of an IC card, there is a fear that IC breaks down due to stress when the label is peeled.

Therefore, even if the above cards have their use life, they are actually discarded immediately at the time of termination of contract, thereby arising economical and environmental problems. Particularly since IC cards are still expensive, they are more uneconomical, and since they includes electronic parts such as an IC chip, the environmental problem is more serious.

As a peelable label, a label having a water-soluble adhesive layer and a label having an adhesive layer including a thermal expansion agent are suggested. However, in the case where such labels are laminated to cards, the former label has a problem of difficult peeling due to alternation of resin, a problem of resin residual resin at the time of peeling, and a problem that a water-soluble component is dissolved due to slight droplets of water or perspiration, and thus the water-soluble component adheres to a hand or cloth of a user or the label is easily peeled due to lowering of adhesion caused by diffluence. Therefore, reproduction of a card cannot be realized easily. Meanwhile, the latter label becomes expensive and requires a special condition such that it is heated at high temperature for peeling, thereby arising a problem that the cost of reuse increases. Therefore, this label is not practically used for reproduction of a card.

### OBJECTS AND SUMMARY

The present invention is devised in order to consider such a condition and its object is to provide an improved information holding medium. More specifically, its object is to provide the improved and reproducible information holding medium. More concretely, its object is to provide the reproducible information holding medium which is capable of being removed easily in a state that a printing label layer does not remain on a substrate, a reproducing method thereof and a reproducing apparatus.

In order to achieve the above object and another object, an information holding medium from a certain aspect of the present invention includes a substrate, a water growth layer provided on the substrate and a printing label layer provided on the water growth layer and adhering thereto. The information holding medium carries out at least printing on the printing label layer so as to hold information.

In the information holding medium from the above aspect, as one form, such a form may be adopted that when water or aqueous solvent is supplied to the water growth layer so that the water growth layer is swelled, the printing label layer is peeled from the substrate, and the water growth layer remains on the substrate. In this case, an intermediate adhesive layer for fixing the water growth layer to the substrate is provided between the water growth layer and the substrate, thereby realizing this form.

In the information holding medium from the above aspect, as another form, such a form may be adopted that when water or aqueous solvent is supplied to the water growth layer so that the water growth layer is swelled, the printing label layer and the water growth layer are peeled from the substrate. In this case, the water growth layer is provided directly on the substrate, thereby realizing this form.

In the information holding medium from the above aspect, as the printing label layer, a printing label layer, which has a surface layer where printing is carried out and an cohesive layer provided on a back surface of the surface layer and has adhesion for making the peeling difficult when the cohesive layer is laminated directly to the substrate without the water growth layer, can be adopted. More preferably, the surface layer has water resistance. As another form, the printing label layer is formed in such a manner that after a coating compound is applied directly to the surface of the water growth layer, it is dried. Preferably, the printing label layer has a thickness of 25 μm to 50 μm.

In the above information holding medium, a size of the water growth layer is the same as or larger than a size of the printing label layer, and the printing label layer is superposed on the water growth layer. Preferably, the water growth layer is made of water growth resin obtained by crosslinking water-soluble resin. Moreover, the information holding medium further has a primary layer and the water growth layer is formed on the primary layer, and the primary layer may be allowed to adhere to the substrate. Moreover, as the substrate, a substrate having a storage circuit can be adopted.

A reproducing method from a certain aspect of the present invention of reproducing the information holding medium supplies water or aqueous solvent to the water growth layer and removes the printing label layer, and adheres a new printing label layer to the water growth layer remaining on the substrate so as to reproduce the information holding medium. Moreover, in the case where the information holding medium has the storage circuit, it updates recording information to be stored in the storage circuit.

A reproducing method from another aspect of reproducing the information holding medium supplies water or aqueous solvent to the water growth layer and removes the printing label layer and the water growth layer, and forms a new water growth layer on the substrate and adheres a new printing label layer to the water growth layer so as to reproduce the information holding medium.

A reproducing apparatus from a certain aspect of the present invention includes liquid supply means for supplying water or aqueous solvent so as to swell a water growth layer, label removing means for removing a printing label layer from the swelled water growth layer, moisture removing means for removing moisture on surface and/or inside of the water growth layer, and label forming means for forming a new printing label layer on the water growth layer form which the printing label layer has been removed.

A reproducing apparatus from another aspect includes liquid supply means for supplying water or aqueous solvent so as to swell a water growth layer, removing means for removing the swelled water growth layer and a printing label layer from a substrate, means for forming a new water growth layer on the substrate, and means for forming a new printing label layer on the new water growth layer.

The reproducing apparatus, in the case where the substrate of the information holding medium has a storage circuit, further includes information updating means for updating storage information to be stored in the storage circuit. Moreover, the reproducing apparatus includes an insertion port into which a used information holding medium is inserted, an insertion port into which an information holding medium without a water growth layer and a printing label layer is inserted.

These and other objects, features and advantages of the present invention will become apparent from the following description of the preferred embodiments when the same is read in conjunction with the accompanying drawings.

### BRIEF DESCRIPTION OF THE DRAWINGS

These and other objects and features of the present invention will become apparent from the following description of preferred embodiments thereof taken in conjunction with the accompanying drawings, in which:

FIG. 1 is an outline view of a card according to a first embodiment;

FIG. 2 is a cross-sectional view in a direction of X-X′ in FIG. 1;

FIG. 3 is a modified example of the card;

FIG. 4 is another modified example of the card;

FIG. 5 is a cross-sectional view of the card according to a second embodiment;

FIGS. 6(a) through 6(f) are diagrams of the card manufacturing steps;

FIGS. 7(a) through 7(e) are diagrams of the card reproducing steps;

FIG. 8 is a structural diagram of a card manufacturing apparatus;

FIG. 9 is a structural diagram of a card reproducing apparatus;

FIG. 10 is a circuit block diagram of the card reproducing apparatus;

FIG. 11 is a flowchart of a reproducing process to be executed by a control section of the card reproducing apparatus;

FIG. 12 is a cross-sectional view of the card according to a third embodiment;

FIG. 13 is a modified example of the card;

FIGS. 14(a) through 14(c) are structural examples of a label to be used when the card is manufactured;

FIGS. 15(a) through 15(e) are diagrams of the card reproducing steps;

FIG. 16 is a structural diagram of the card manufacturing apparatus;

FIG. 17 is a modified example of the card manufacturing apparatus;

FIG. 18 is across-sectional view of the card according to the third embodiment; and

FIG. 19 is a structural diagram of a card manufacturing/reproducing apparatus.

In the following description, like parts are designated by like reference numbers throughout the several drawings.

### DETAILED DESCRIPTION OF THE PREFERRED EMBODIMENTS

<First Embodiment of Card>

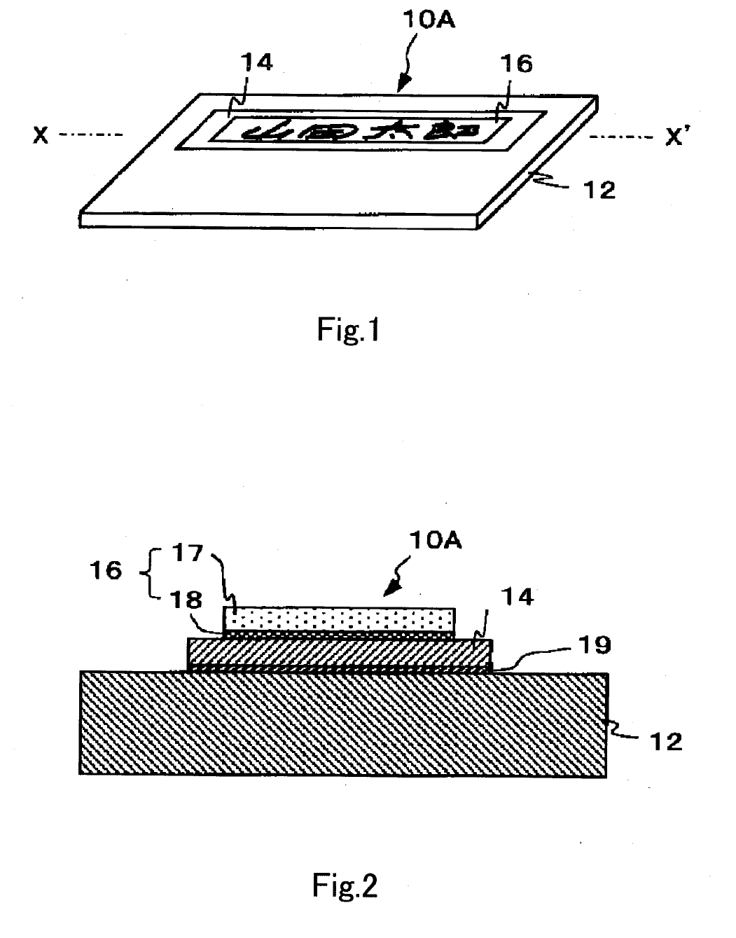

FIG. 1 is an outline drawing of a card according to a first embodiment as a reproducible article of the present invention. FIG. 2 is a schematic cross-sectional view in a direction of X-X′ in FIG. 1. As shown in FIGS. 1 and 2, a card 10A of the first embodiment is constituted so that an adhesive label 16 to be a signature section is laminated to a card-shaped substrate 12. A band-shaped water growth layer 14 is provided between the adhesive label 16 and the substrate 12.

As the substrate 12, an IC card, which contains an IC chip including a central processing unit (CPU), a ROM for storing a program or the like, a RAM and EEPROM as storage circuits for holding data, is used here. As the IC card, various cards, such as a contact type IC card having external contact point, a noncontact type IC card to be utilized for noncontact and a hybrid card in which contact/noncontact cards are integrated, can be used. In the present embodiment, in order to peel an adhesive label 16 by supplying a liquid such as water to the card as mentioned later, it is preferable that a noncontact type IC card, which further include a RF circuit for performing modulation/demodulation at the time of supplying a power and transmitting data and an antenna coil, is used.

When a user holds the card 10A, the user write his/her signature on the label as the signature section using arbitrary writing instruments such as a pen or a pencil in like manner this is currently performed on a credit card or a cash card. As a result, even in the case where the card is used for applications such as a credit card, a cash card, a commutation ticket, an ID card, a passport, an ID card in a company, a member's card, a pass, and a point card, the user can designate that the card is his/her belonging. Another information, such as address, date of birth, and telephone number may be autographed. In FIG. 2, a reference number 50 designates a printing material.

As shown in FIG. 2, the adhesive label 16 is composed of a surface layer 17 and a cohesive layer 18 on the back surface. The surface layer 17 is made of a material, a surface of which is writable using writing instruments. The cohesive layer 18 is used for adhering the surface layer 17 to the substrate 12 so that it is not peeled at the time of actual use.

As the adhesive label 16, adhesive bodies for printing, in which a cohesive layer such as glue or acrylic resin adhesive is formed on a back surface of paper, a resin film or the like can be used. The adhesive bodies for printing include various adhesive stickers, various adhesive tapes and various adhesive labels on the market. A correction tape on the market can be also used.

The surface layer 17 may be paper such as paper stickers and paper label on the market. However, from the viewpoint such that the surface layer 17 is prevented from being soaked with water and becoming weak at the peeling step of the adhesive label 16, mentioned later, and from being partially fractured from the adhesive layer 18, it is preferable that paper including paper strength additive (synthetic resin such as polyethylene), polyethylene terephthalate fiber paper (for example, reproduced PET fiber paper RIPETKING or the like made by Daio Paper Corporation.), non-woven fabrics such as dry pulp non-woven fabric, dry non-woven fabric, wet non-woven fabric are used. When a material with excellent water resistance and water permeability is used for the surface layer, even if the surface layer is soaked in water for a long time, it is not fractured and water reaches the water growth layer for a short time, thereby shortening the time required for peeling by 30% to 50% in comparison with a paper label.

As the cohesive layer 18, general pressure sensitive adhesive, such as glue or acrylic resin pressure sensitive adhesive, or double-sided tape can be used, and when the cohesive layer 18 is laminated directly to the substrate, a cohesive layer having strong adhesion for making the peeling difficult can be used.

It is preferable that a thickness of the adhesive label 16 is not too large in order to prevent an end of the adhesive label 16 from being caught at the time of use, or in order to sufficiently secure a penetration speed of water to a thicknesswise direction. A suitable thickness range is about 25 μm to 50 μm.

The water growth layer 14 is swelled by supplying water or aqueous solvent thereto, but it substantially dissolves but is not mixed in another material. As shown in FIG. 2, in the present embodiment, the water growth layer 14 is fixed to the substrate 12 by the intermediate adhesive layer 19, and even if it undergoes the peeling step of the adhesive label, mentioned later, it continues to exist on the substrate 12.

The water growth layer 14 is made of a water growth resin. Water growth resin is prepared by crosslinking water-soluble resin. Moreover, in combination with such crosslinking, a non-water-soluble component is added to the water-soluble resin so as to provide a characteristic which absorbs a solvent such as water and swells but is unsolved with the solvent.

As the water-soluble resin, water-soluble resin, which has functional group having active hydrogen such as hydroxyl group, carboxyl group, amino group, amide group, thiol radical or sulfonic group in molecules, can be used. The water-soluble resin includes polyvinyl alcohol, polyacrylic acid, methyl cellulose, carboxymethyl methyl cellulose, hydroxyethyl cellulose, polyvinyl pyrrolidone, polyacrylamide, diacetone acrylamide, and polyethylene oxide. In them, resin having hydroxyl group or carboxyl group is used, and such resin includes polyvinyl alcohol and polyacrylic acid.

In addition, the water-soluble resin may be ion-derivatized. Here, the ion derivatizing means that ionicity is further given to water-soluble resin. The water-soluble resin is ion-derivatized in such a manner, so that hydrophilicity of of the water-soluble resin is improved, thereby improving water absorbing property of the water growth layer to be obtained and increasing a swelling speed of the water growth layer.

As a crosslinker, crosslinkers, which have reactivity to the functional group such as hydroxyl group, carboxyl group or amide group existing in the molecules of the water-soluble resin and can crosslink the water-soluble resin, may be used. For example, such crosslinker includes epoxy compound, methylol compound, aldehyde compound, isocyanate compound, aziridine compound, carboxylic compound and hydrazide compound. In the case where the water-soluble resin is resin having hydroxyl group such as polyvinyl alcohol or methylcellulose, the epoxy compound, the methylol compound, aldehyde compound, isocyanate compound or the like is preferable as the crosslinker. Moreover, in the case where the water-soluble resin is resin having carboxylic group such as polyacrylic acid, as the crosslinker, epoxy compound, isocyanate compound or aziridine compound is suitable. In such a manner, the crosslinker depends on the water-soluble resin to be used and is determined, but from the viewpoint of an improvement in a repeating label removing performance and a label removing performance at the time of standing, in the above crosslinkers, the epoxy compound, the methylol compound or aldehyde compound is preferable, and the epoxy compound is more preferable.

The epoxy compound is not particularly limited as long as it contains epoxy ring, and it includes, for example, polyethylene glycol diglycidyl ether, glycerol polyglycidyl ether, polypropylene glycol diglycidyl ether and sorbitol polyglycidyl ether.

The methylol compound is not particularly limited as long as it has two or more methylol groups in one molecule. The methylol compound includes, for example, methylolated melamine such as dimethylol melamine or trimethylol melamine, dimethylol urea and melamine-formamide resin. Besides them, various methylol compounds can be used. It is preferable that compounds have more methylol groups, moderately higher molecular weight and moderately longer molecular chain because more satisfactory repeating label removing performance and label removing performance at the time of standing can be obtained. From this viewpoint, in the above methylol compounds, melamine-formaldehyde resin is preferable.

The aldehyde compound is not particularly limited as long as it has two or more aldehyde groups in one molecule. The aldehyde compound includes, for example, glutaraldehyde, glyoxal and the like, but it is not limited to them.

The isocyanate compound which has two or more isocyanate groups in one molecule can be used. The isocyanate includes 4,4′-diphenylmethane diisocyanate, 4,4′-methylenebis cyclohexyl isocyanate, tris (p-isocyanatephenyl) methane, tolylen diisocyanate-3 appendage of trimethylolpropane, and aliphatic polyisocyanate having hydrophilic group in molecules. The isocyanate compound may be protected by phenol, sulfite or the like.

The aziridine compound includes, for example, diphenylmethane-bis-4.4′-N,N′-diethyl urea, 2,2′-bishydroxymethylbutanol-tris-[3-(1-aziridiynyl)propionate] and the like. Moreover, polymer containing oxazoline group can be used.

The carboxylic compound is not particularly limited as long as it has two or more carboxylic groups in one molecule. The carboxylic compound includes, for example, glutaric acid, adipic acid and the like, but it is not limited to them. As compounds having more carboxylic groups are used, more satisfactory repeating label removing performance and label removing performance at the time of standing can be obtained.

The hydrazide compound includes, for example, adipic acid dihydrazide and the like, but it is not limited to it.

In the case where the above compounds are added as the crosslinker, 0.1 to 100 parts by weight of the compound is added to 100 parts by weight of the water-soluble resin, preferably 1 to 50 parts by weight of the compound is added. When the amount is too small, there arises a problem of insufficient strength of the water growth layer at the time of swelling, and the water growth layer is possibly dissolved. When the amount is too large the crosslinker becomes a bulk component, there arises a problem of strength or the like of the water growth layer. When two or more crosslinkers are combined to be used, the performance is occasionally further heightened. In this case, a total amount may be within the above range.

The water growth layer may contain reaction accelerator. The existence of reaction accelerator improves a speed of crosslinking reaction, there by obtaining an excellent effect such that a stable water growth layer with less aging can be obtained even if it is stored under any environments.

The reaction accelerator is not particularly limited as long as the above crosslinking reaction acceleration effect and the label removing performance maintaining effect are obtained. As the reaction accelerator, various compounds, which have water solubility and show acid, alkalinity or neutrality in an aqueous solution, can be used. The water solubility is such a property that when the reaction accelerator of a following amount is contained in a surface layer coating solution at room temperature, the entire reaction accelerator can dissolve in water.

As an acid compound to be used as the reaction accelerator, publicly-known inorganic acid or organic acid can be used. Concretely, the inorganic acid includes, for example, hydrochloric acid, sulfuric acid, nitric acid, phosphoric acid and the like. The organic acid includes acetic acid, oxalic acid, tartaric acid, benzoic acid and the like. Preferably, the inorganic acid, particularly hydrochloric acid is used. A use amount of the acid compound is not particularly limited, but it may be added so that pH of the coating liquid including at least the water-soluble resin, the crosslinker and the reaction accelerator is about 1 to 5 when the water growth layer is formed. Normally, 0.1 to 10 parts by weight of the acid compound is used with respect to 100 parts by weight of the water-soluble resin.

As the alkaline compound, publicly-known inorganic hydroxide, ammonia, organic amine, carbonate and bicarbonate of alkali metal, and imino compound can be used. The inorganic hydroxide includes, for example, hydroxide of alkali metal or alkaline earth metal, and its concrete examples are sodium hydroxide, potassium hydroxide, lithium hydroxide, magnesium hydroxide, calcium hydroxide and the like. The organic amine includes, for example, methylamine, dimethylamine, trimethylamine, ethylamine, diethylamine, triethylamine and the like. The alkali metal carbonate includes, for example, sodium carbonate, potassium carbonate and the like. The alkali metal bicarbonate includes, for example, sodium bicarbonate, potassium bicarbonate and the like. The imino compound includes, for example, imidazole and the like. Preferably the inorganic hydroxide, particularly sodium hydroxide and potassium hydroxide are used. A use amount of the alkaline compound is not particularly limited, but it may be added so that pH of the coating liquid when the water growth layer is formed becomes about 9 to 13. Normally, 0.1 to 100 parts by weight of the alkaline compound is used with respect to 100 parts by weight of the water-soluble resin.

As the neutral compound, for example, borofluoride and quaternary ammonium salt can be used. The borofluoride includes, for example, zinc borofluoride, lead borofluoride, tin borofluoride and the like. The quaternary ammonium salt includes, for example, tetramethylammonium chloride and the like. Preferably the borofluoride, particularly zinc borofluoride is used. A use amount of the neutral compound is not particularly limited or normally 0.1 to 20 parts by weight with respect to 100 parts by weight of the water-soluble resin 100.

In the case where the epoxy compound is used as one of the crosslinkers, it is preferable that the inorganic acid, inorganic hydroxide, the organic amine, the imino compound, borofluoride or the quaternary ammonium salt is used as reaction accelerator. The inorganic acid, inorganic hydroxide or borofluoride is more preferable. The hydrochloric acid, sodium hydroxide, potassium hydroxide or borofluoride is most preferable. The reaction accelerator is used so that the effect of the present invention can be obtained effectively.

Particularly in the case where as the water-soluble resin, polyvinyl alcohol and/or polyacrylic acid are/is used and epoxy compound is used as one of the crosslinkers, it is effective that inorganic acid, inorganic hydroxide or borofluoride is used, preferably hydrochloic acid, sodium hydroxide, potassium hydroxide or zinc borofluoride is used as the reaction accelerator.

Single or combinations of reaction accelerator(s) may be used, but it is preferable that acid compound and alkaline compound are not combined. When these compounds are combined, the effect of the present invention tends to be difficultly obtained. In the case where two or more reaction accelerators are used, a total amount may be 0.1 to 20 parts by weight, preferably 1 to 10 parts by weight with respect to 100 parts by weight of water-soluble resin.

In addition, publicly-known inorganic fine particles such as silica, titanium oxide, alumina, zinc oxide or calcium carbonate, and publicly-known organic fine particles such as poly (metha) acrylic ester may be added to the water growth layer. When such fine particles are added, 0.5 to 200 parts by weight of fine particles, preferably 10 to 100 parts by weight of fine particles are added with respect to 100 parts by weight of the water-soluble resin.

Further, antistatic additive may be added to the water growth layer as the need arises. The antistatic additive may be added to a material forming the surface layer, or the antistatic additive is dissolved and dispersed in a suitable solvent so as to be applied to the formed surface layer. The antistatic additive includes cationic surface active agent such as quaternary ammonium salt.

The water growth layer made of the above materials is formed in such a manner that the water-soluble resin, the crosslinker and a desired additive such as reaction accelerator, fine particles or antistatic additive are dissolved and dispersed in a suitable solvent such as water, a mixed solvent of water and organic solvent, or organic solvent, and the obtained coating liquid is applied to the substrate by the publicly-known coating method such as a solvent coating method and is heated and the water-soluble resinis crosslinked. The substrate may be coated with the coating liquid so that a coating amount on one surface after heating and drying becomes 0.5 to 30 g/m², more preferably 2 to 20 g/m².

In the case where aqueous solvent is used, when the coating liquid for the water growth layer contains a surface active agent, coating and formation of the surface layer become easy, thereby obtaining an effect that permeability of water into the water growth layer is improved. As the surface active agent, anionic, nonionic and cationic surface active agents can be used, and it is not particularly limited. An adding amount is suitably 0.1 to 20 weight %, preferably 0.5 to 10 weight % with respect to the water-soluble resin.

After the coating, it is preferable that the coated layer is once dried. From the viewpoint of the manufacturing efficiency, a lower drying temperature is preferable and a shorter drying time is preferable. Concretely, the coated layer is heated at 20 to 180° C., preferably 30 to 140° C. for 0.1 to 20 minutes, preferably 0.5 to 10 minuets.

At the time of crosslinking, concretely the coated layer is heated at 20 to 250° C., preferably 100 to 180° C. for not less than 5 seconds, preferably 5 seconds to 3 minutes, more preferably 10 seconds to 2 minutes. This heating enables the water growth layer, which can stably maintain the satisfactory label removing performance under any storage environment, to be formed. A monomer and/or a oligomer compound(s) having double bond for capable of composing a non-water-soluble component are/is added to the coating liquid for the water growth layer, and ultraviolet rays or electron beams may be emitted thereto simultaneously with the heating.

The solubility of the water growth layer is not more than 10, preferably 0.5 to 8. In the specification, the solubility means a melting weight (g) with respect to 100 g of water of 20° C., and a value measured by the following method is used. However, the measuring method is not limited to the following one as long as the solubility can be obtained. Concretely, a card of 5 cm (longitudinal)×5 cm (horizontal) is soaked in water (0.1 l) of 20° C. for 3 minutes so that a component is eluted. A weight of the component is calculated from a different in weight of the card (difference between before-soaking and after-soaking).

The intermediate adhesive layer 19 provided between the substrate 12 and the water growth layer 14 is made of resin with high adhesion and the intermediate adhesive layer 19 includes a compound (reactive compound) having a functional group chemically bonding with the resin composing the water growth layer if desired. As a result, the adhesion and bonding property between the intermediate adhesive layer 19 and the water growth layer 14 can be improved.

The resin with high adhesion composing the intermediate adhesive layer includes urethan resin, acrylic resin, styrene resin, polyester resin, polycarbonate resin, vinyl acetate resin, vinyl chloride resin and the like. Preferably, it includes urethane resin, polymethyl methacrylate resin, polyester resin, polycarbonate resin, vinyl chloride resin and the like.

The reactive compound included in the intermediate adhesive layer if desired is not particularly limited as long as it has the functional group which can chemically bonds with the resin composing the water growth layer. For example, an epoxy compound, a methylol compound, an aldehyde compound, an isocyanate compound, an aziridine compound, a carboxylic compound, a hydrazide compound and the like can be used. Concrete example of these compounds are the similar compounds to the above compounds exemplified as the crosslinkers of the water-soluble resin composing the water growth layer.

The reactive compound may be of solid at room temperature or wax type or viscous liquid at room temperature. When the reactive compound is solid at room temperature or wax type or viscous liquid at room temperature, it is not evaporated due to drying at the time of coating and formation of the intermediate adhesive layer. Further, since its surface is not sticky at the time of drying, coating to the surface layer becomes easy. Moreover, when the reactive compound which dissolves with water or is compatible with water, is used, it is not necessary for coating and formation of the intermediate adhesive layer to use an organic solvent, there by preventing the organic solvent from remaining in the intermediate adhesive layer. An adding amount of the reactive compound can be, for example, 5 to 50 parts by weight with respect to 100 parts by weight of the intermediate adhesive layer resin.

The substrate 12 can be coated with the intermediate adhesive layer 19 by a solvent coating method, a solution coating method or the like for applying and drying a solution which is obtained by liquid-disociating the resin, and the reactive compound, if necessary, in a suitable solvent, such as water, tetrahydrofuran (THF), dioxane, acetone, acetic ether, methyl ethyl ketone (MEK) or a mixed solvent of them. Such a solution can be obtained by dissolving or dispersinsg resin, such as water-soluble or hydrophilic polyurethane or polyester, in water. Such a resin solution and resin emulsion are on the market, and when they are used, there is an advantage that a coating film can be formed without using an organic solvent, particularly non-water-soluble organic solvent. For this reason, safety at the time of manufacturing can be improved. Moreover, a problem that when a card is heated at the reproducing step, mentioned later, a gas of a residual solvent is generated from the inside can be suppressed. In the case where a water-soluble solvent is used, a surface active agent is added thereto, thereby easily coating the substrate with the intermediate adhesive layer. When both the intermediate adhesive layer 19 and the water growth layer 14 are formed by a water-soluble solvent, a card can be manufactured without using a nonaqueous organic solvent, thereby preventing problems of safety and residual nonaqueous organic solvent in the card. The intermediate adhesive layer is formed by the solvent coating method or the solution coating method so that a coating amount on one side is about 0.5 to 20 g/m², preferably 1 to 15 g/m². When a coating amount is less than 0.5 g/m², irregular coating is easily generated, and there is a fear that a problem of heating resistance or the like arises.

When the reactive compound has high molecular weight and has deposition property and excellent adhesion to the substrate, the reactive compound is dissolved in a solvent or the like and is applied and dried so that the intermediate adhesive layer can be formed. The intermediate adhesive layer may be subject to a corona discharging process. In the case where the substrate made of paper or fiber is used, the substrate is soaked in a coating solution for forming the intermediate adhesive layer, and the substrate is immersed in the coating solution so that gap between fibers composing the substrate are filled with the intermediate adhesive layer material.

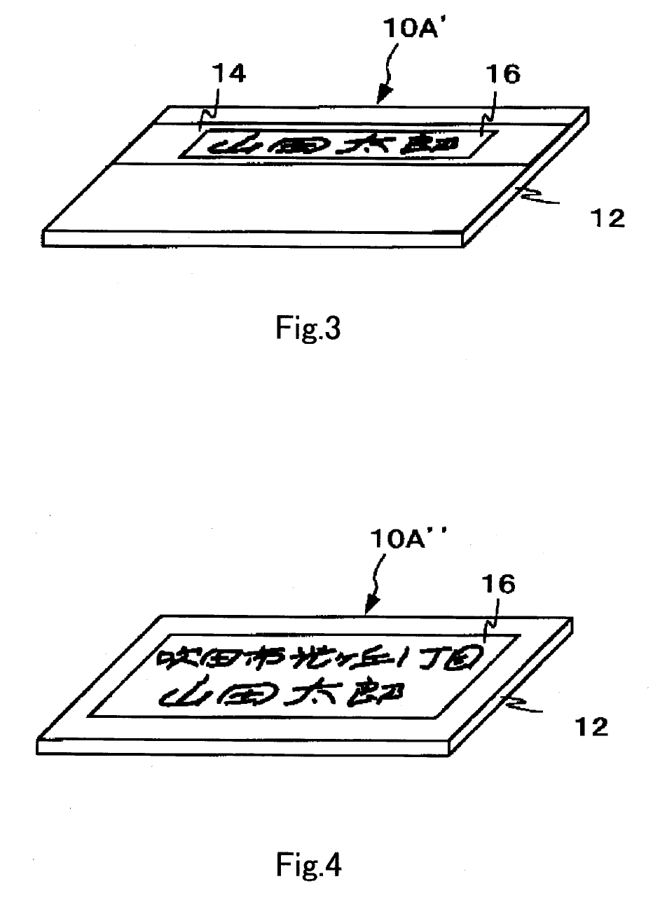

FIGS. 3 and 4 are diagrams showing modified examples of the card 10A. In FIGS. 1 and 2, the water growth layer 14 is provided only at the center of the substrate 12, but in a card 10A′ shown in FIG. 3, the water growth layer 14 reaches both ends of the substrate 12. This structure facilitates the coating and formation of the water growth layer using a roll coater or the like. Since a portion of the water growth layer 14 uncovered with the label 16 does not become sticky nor disappear due to slight moisture, it is allowable for actual use.

In addition, in FIGS. 1 and 2, the adhesive label 16 is provided so as to have smaller width and length than those of the water growth layer 14, but in a card 10A″ shown in FIG. 4, both of them having the same size are overlapped with each other in one position. This reduces a coating amount of the water growth layer material minimally.

<Second Embodiment of Card>

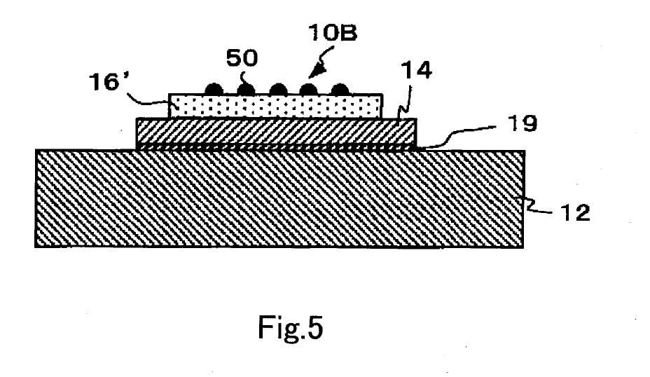

FIG. 5 is a schematic cross-sectional view showing the second embodiment of the card. A card 10B of the present embodiment has a structure that an adhesive label without a cohesive layer is used in the card 10A of the first embodiment. In other words, the surface layer 17 of the card 10A adheres directly to the water growth layer so that a label layer 16′ is formed. Such a label layer 16′ can be formed by coating the surface of the water growth layer with coating compound and drying it. As the coating compound, lacquer, paint, correction fluid or the like can be used. It is preferable that the coating compound is white because it can cope with writing instruments with various colors. Moreover, when the formed surface layer 17 has moderate roughness, it can cope with a lot of writing instruments such as a pencil. When the surface layer material exemplified in the first embodiment is used and this is overlapped on the water growth layer 14 in the swelled state and is dried, adhesion of a certain degree can be secured. For this reason, The label layer 16′ can be formed without using a coating liquid.

<Manufacturing Example of Card>

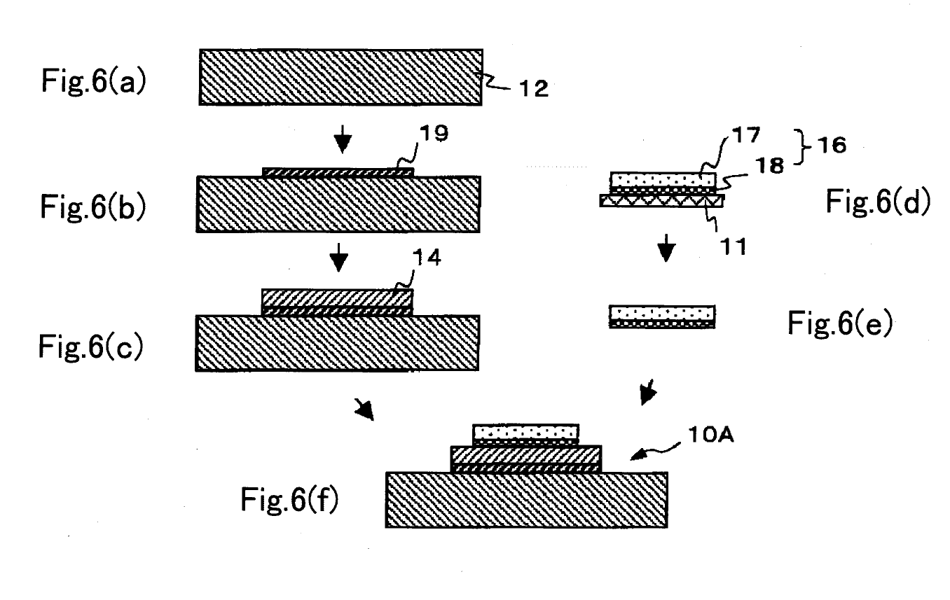

FIGS. 6(a) through 6(f) are manufacturing step diagrams showing one example of the manufacturing steps of the card 10A. There will be explained below the manufacturing steps with reference to FIGS. 6(a) through 6(f).

Firstly, the substrate 12 is coated with the intermediate adhesive layer material and is dried, so that the intermediate adhesive layer 19 is formed (see FIGS. 6(a) and 6(b)). Next, the intermediate adhesive layer 19 is coated with a water growth resin material and is subject to a heating process, so that the water growth layer 14 is formed (see FIGS. 6(b) and 6(c)). A releasing sheet 11 is peeled from the adhesive label 16 with the releasing sheet (see FIGS. 6(d) and 6(e)), and the surface of the cohesive layer 18 of the adhesive label 16 is laminated onto the water growth layer 14 so that the card 10A is completed (see FIG. 6(f)).

In the case of the card 10B, the water growth layer 14 of FIG. 6(c) is coated with a coating compound and is dried, so that the card 10B is completed.

<Reproducing Example of Card>

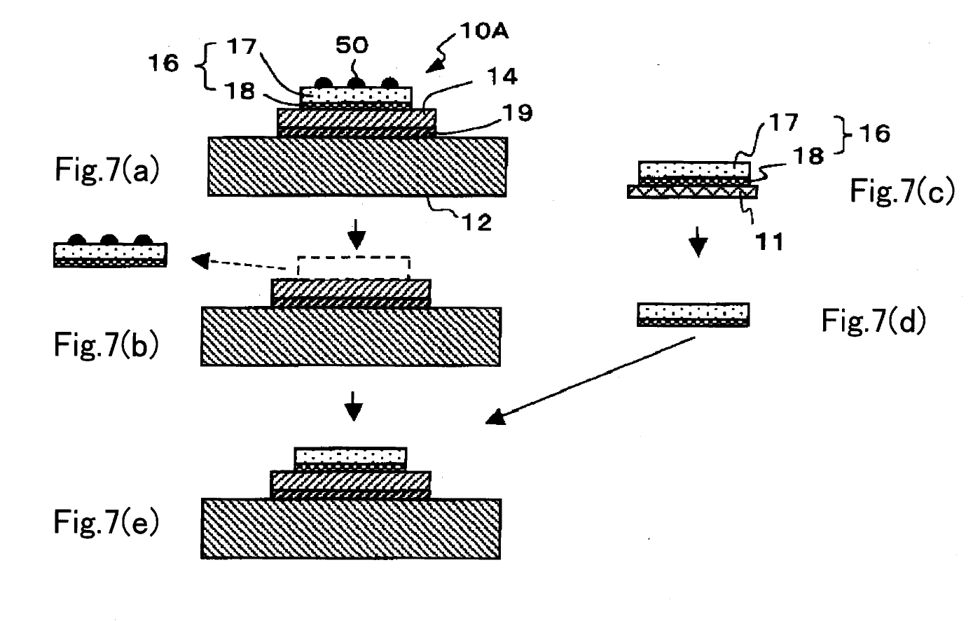

FIGS. 7(a) through 7(e) are step diagrams showing one example of the reproducing steps of the card 10A. There will be explained below the reproducing steps with reference to FIGS. 7(a) through 7(e).

Firstly water or aqueous solvent such as water-soluble liquid or aqueous organic solvent is supplied to the adhesive label 16 portion of the used card 10A in which characters or the like (the recording material is designated by reference number 50) are written on the surface layer 17 of the adhesive label 16. As a result, the liquid impenetrates into the water growth layer 14 after the liquid passes through the adhesive label 16 or from the circumference of the adhesive label 16, so that the water growth layer 14 swells. As a result, the adhesion between the cohesive layer 18 and the water growth layer 14 is weakened. Although the grade is different according to the adhesion, material and the like of the adhesive label, when the water growth layer swells, generally the adhesion to the label is greatly lowered, and the cohesive layer does not remain on the water growth layer, so that the adhesive label can be peeled from the water growth layer very easily. Therefore, the adhesive label 16 is peeled from the water growth layer 14 (see FIGS. 7(a) and 7(b)).

Details of the mechanism for peeling the adhesive label 16 from the water growth layer 14 are not clear, but its main factors are presumed that the water growth layer 14 swells on the adhesive portion between the adhesive label 16 and the water growth layer 14 so that a stress is applied to the adhesive label 16, and a liquid intervenes between the water growth layer 14 and the adhesive label 16 (more concretely, the cohesive layer 18) due to infiltration of the liquid into the surface direction of the water growth layer 14 so that the adhesion therebetween is weakened. In any factors, the water growth layer does not dissolve in the liquid nor disappear after swelling and remains on the substrate side, when it is dried, it returns to its original state.

The liquid for swelling the water growth layer includes water, a mixed solvent of water and water-soluble organic solvent, water-soluble organic solvent, a solution of water soluble substance and the like. The liquid may include a suitable additive such as a surface active agent. As a condition for swelling the water growth layer, it is preferable that a temperature of the liquid is 5° C. to 35° C., and the water growth layer is brought into contact with the liquid for about 15 to 300 seconds.

After the adhesive label 16 is peeled, moisture adhered to the substrate or the surface of the water growth layer is removed or the water growth layer 14 is dried if necessary. The removal and drying of moisture are carried out to an extent that lamination of a new label is not disturbed, and at least to an extent that water drops are moved from the surface, preferably an extent that the swelled resin is dried and returns to its approximately original thickness. When water drops are removed, a sponge type absorbing member may be put on the water growth layer 14 or airflow may be insufflated thereonto. The water growth layer is returned to its original state by adopting a method of heating, insufflating hot air or exposing it to a drying atmosphere.

Next, the releasing sheet 11 is peeled from the adhesive label 16 with releasing sheet (see FIGS. 7(c) and 7(d)), and the surface of the cohesive layer 18 is laminated so as to be opposed to the water growth layer 14, so that the reproduction of the card 10A is completed (see FIG. 7(e)).

In the case of the card 10B, the label is removed similarly to the case of the card 10A, the water growth layer 14, from which adhered moisture is removed or is dried if necessary (FIG. 7(b)), is coated with a coating compound and is dried so that the reproduction of the card 10B is completed.

In the present embodiment where an IC card is used as the substrate, when the IC card is reproduced and reused by the above method, an effective price of the IC card can be reduced dramatically, thereby preventing the wastage of resources such as IC and circuit forming metal and preventing environmental pollution. Moreover, since printing is not carried out on the water growth layer but on the label adhered to the water growth layer, there is an advantage that a writing material is not limited because various writing instruments such as dye ink, pigment ink and pencil can be used.

### EXAMPLE OF CARD MANUFACTURING APPARATUS

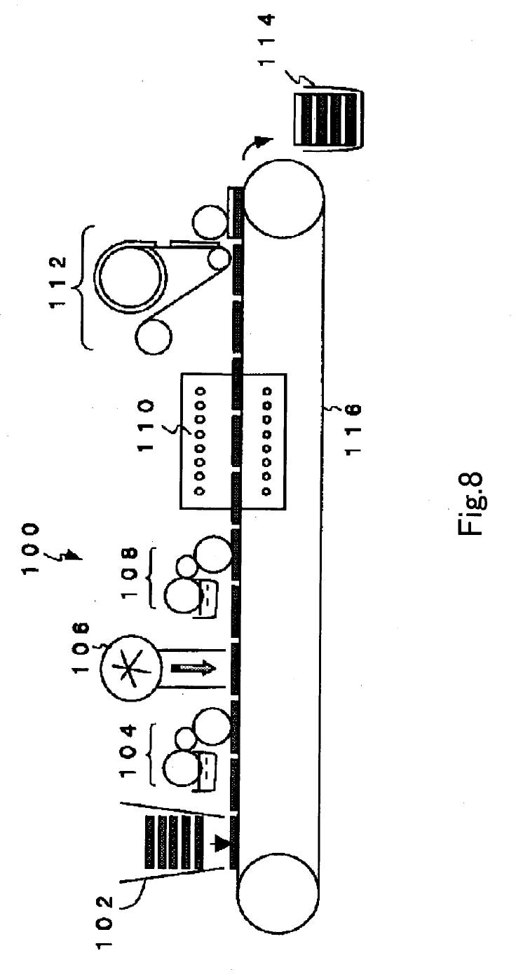

FIG. 8 is a structural diagram showing one example of the card manufacturing apparatus for manufacturing the card 10A. As shown in FIG. 8, the card manufacturing apparatus 100 has a card hopper 102, an intermediate adhesive layer coating device 104 such as a roll coater, a dryer 106, a water growth layer coating device 108 such as a roll coater, a heating device 110, a label applicator 112, a card housing container 114, and a transport belt 116. The card hopper 102 houses IC cards unprovided with adhesive labels and water growth layer. The dryer 106 dries a coated intermediate adhesive layer material. The heating device 110 heats and cures a coated water growth layer material. The label applicator 112 laminates an adhesive label onto a card. The card housing container 114 houses cards on which adhesive labels have been laminated. The transport belt 116 transports IC cards.

In the apparatus 100, firstly an IC card supplied from the card hopper 102 is placed on the transport belt 116. The intermediate adhesive layer material is applied to the IC card into a band shape by the coating device 104, and is dried with hot air by the dryer 106.

Next, the water growth layer material is applied thereto into a band shape by the coating device 108, and the the water growth layer material is heated to be cured by the heating device 110 so that the water growth layer is formed. Simultaneously the water growth layer is bonded with the intermediate adhesive layer strongly and is fixed to the IC card as the substrate.

Finally, a releasing sheet is peeled from an adhesive label roll in which the releasing sheet has been laminated onto its adhesive surface, and the adhesive label is laminated onto the water growth layer of the card by the label applicator 112. In such a manner, the card with the label is completed so as to be housed in the housing section 114.

In the case where the label is formed by using a coating compound like the card 10B, this is similar to the above case in that a liquid such as water is given, so that the water growth layer swells and the adhesion between the label and the water growth layer is weakened. The label layer can be peeled very easily. In this case, the manufacturing apparatus may be provided with a coating device for a coating compound and a dryer for drying the applied coating compound instead of the label applicator 112.

In any case, in the present embodiment, although it is difficult to peel a seal, a label, a tape, a coating liquid and the like which have been laminated directly to the substrate, they can be widely used, and they may be selected suitably taking a price, writing property, peeling easiness and the like into consideration. Therefore, a degree of freedom in selection of materials in the card manufacturing is high.

### EXAMPLE OF CARD REPRODUCING APPARATUS

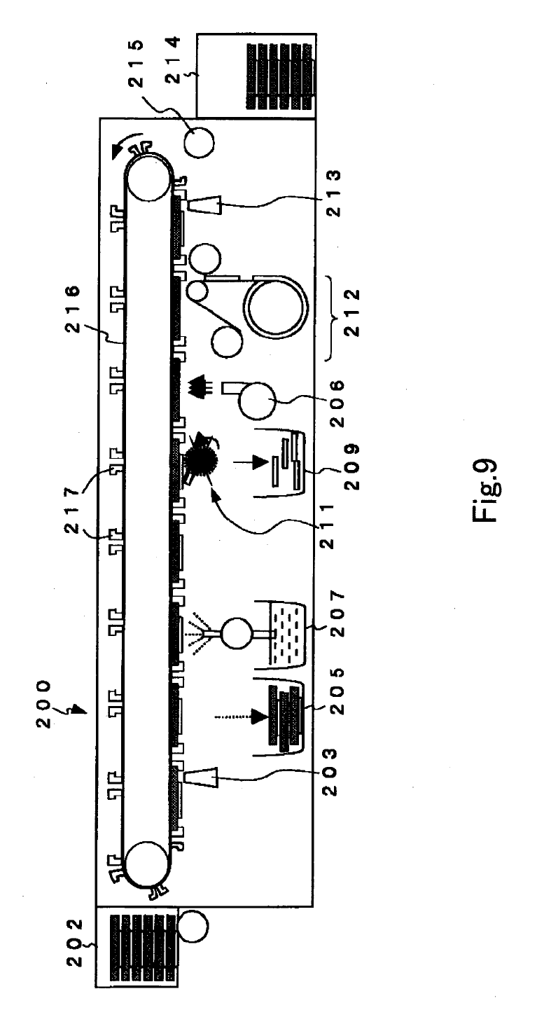

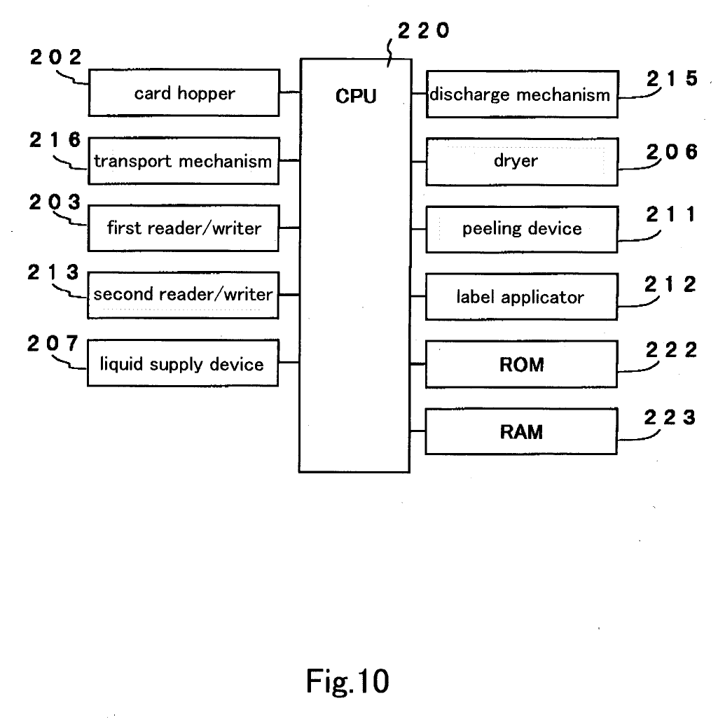

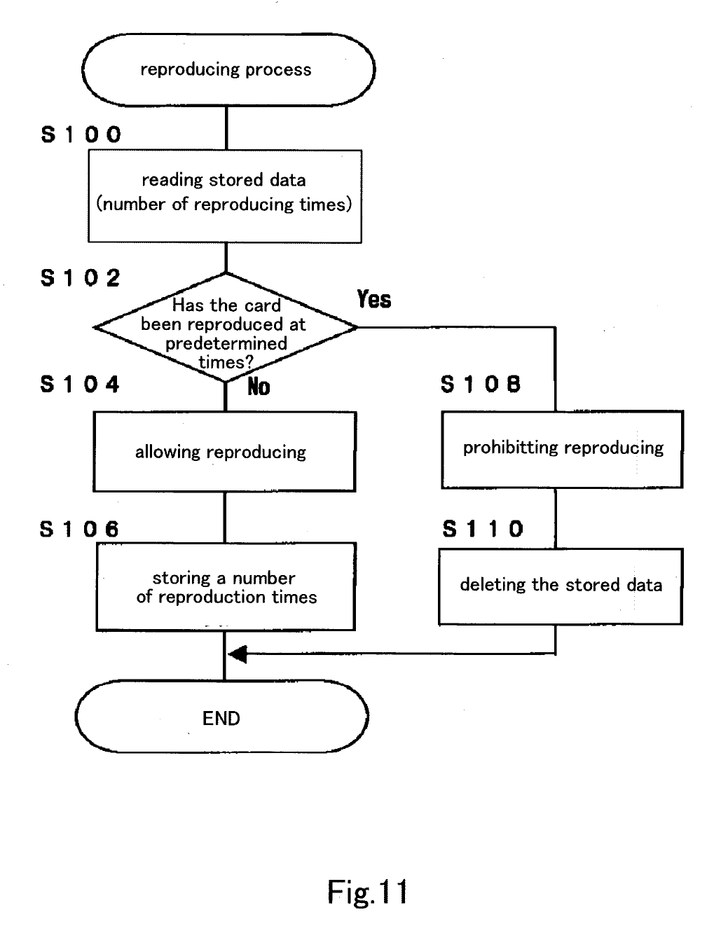

FIG. 9 is a structural diagram showing one example of a reproducing apparatus for reproducing the card 10A. FIG. 10 is a control circuit block diagram of the reproducing apparatus shown in FIG. 9. FIG. 11 is a flowchart of a reproducing process to be executed by the control circuit of the reproducing apparatus shown in FIG. 10.

As shown in FIG. 9, the card reproducing apparatus 200 includes a used card hopper 202, a first reader/writer 203, a defective card recovery container 205, a liquid supply device 207, a peeling device 211, a label recovery container 209, a dryer 206, a label applicator 212, a second reader/writer, a discharge mechanism 215, a reproduced card housing section 214 and a transport mechanism 216. The used card hopper 202 houses used IC cards. The first reader/writer 203 reads data stored in an IC chip of an IC card. The liquid supply device 207 supplies a liquid to a card. The peeling device 211 peels an adhesive label from a card. The label recovery container 209 recovers a peeled label. The dryer 206 dries a card. The label applicator 212 laminates a new adhesive label to a card. The second reader/writer writes data into an IC chip of an IC card if necessary. The discharge mechanism 215 discharges a reproduced card. The reproduced card housing section 214 houses discharged cards. The transport mechanism 216 transports cards.

In addition, as shown in FIG. 10, the reproducing apparatus 200 includes a central processing unit (CPU) 220 for controlling the entire apparatus, a ROM 222 for storing control programs, various data and the like, and a RAM 223 for stores various information. The respective sections shown in FIG. 9 are controlled by the CPU 220.

In the reproducing apparatus 200, firstly a used IC card supplied from the hopper 202 is transported into the card reproducing apparatus 200 by the transport device 216 having an IC card hold mechanism 217. The first reader/writer 203 reads stored data in the IC card, and judges the IC card which has been reproduced at predetermined times as a reproduction defective card. The holding of the reproduction defective card by means of the hold mechanism 217 is released so that the reproduction defective card is excluded from sorting and is recovered in the recovery container 205 (see steps S100, S102 and S108 in FIG. 11). At this time, the first reader/writer 203 deletes the stored data in the IC card if necessary (see step S110 in FIG. 11).

When the number of reproduction times is less than a predetermined number of times, the reproduction is permitted (see step S104 in FIG. 11), water is supplied to the adhesive label, and the water is infiltrated into the water growth layer so that the water growth layer is swelled. As a result, the adhesive label is in the easily peeling state. In the liquid supply device 207 of the reproducing apparatus 200, since a liquid is supplied from below in the vertical direction by a shower system, the card is not unnecessarily soaked in the water. It is noted that the mechanism for supplying a liquid includes a system for bringing a label into contact with a surface of a liquid stored in a liquid reservoir tank, a system for bringing the label into contact with mist generated by a ultrasonic wave or the like, a system for soaking the card in a liquid besides the shower system shown in the drawing.

Next, a mechanical force is applied to the adhesive label by the peeling member 211 such as a brush or a blade, so that the adhesive label is peeled from the water growth layer. In the case where an IC card as the substrate has sufficient water resistance, the entire card may be soaked in water. In this case, the mechanical force for peeling is not required as long as the adhesive label is naturally peeled by soaking the card in water for predetermined time.

After the adhesive label is peeled, the moisture remaining on the water growth layer is dried to be removed with hot air by the dryer 206. The moisture may be wiped away by a sponge member or the like before hot air drying. The water growth layer may be simply rinsed with water before wiping away, if necessary.

A releasing sheet is peeled from an adhesive label roll in which the releasing sheet is laminated to the adhesive surface, so that the adhesive label is laminated to the water growth layer by the label applicator 212.

Thereafter, the second reader/writer 213 records data in the IC chip of the IC card, if necessary. In the case where a card is reproduced at times which exceeds durability of the water growth layer, there is a fear that peeling of the adhesive label is defective. For this reason, if a storage capacity is enough, a number of reproduction times may be stored as data (see step S106 in FIG. 11). When a number of reproduction times is stored, a judgment can be made as to whether a number of reproduction times exceeds a specified value at the time of next reproduction. A card which reaches a predetermined number of reproduction times can be previously stopped to be reproduced, and there is no fear that the defective card is mixed.

In such a manner the card to which the new adhesive label is laminated is reproduced, and it is discharged by the discharge mechanism 215 so as to be housed in the housing section 214.

<Third Embodiment of Card>

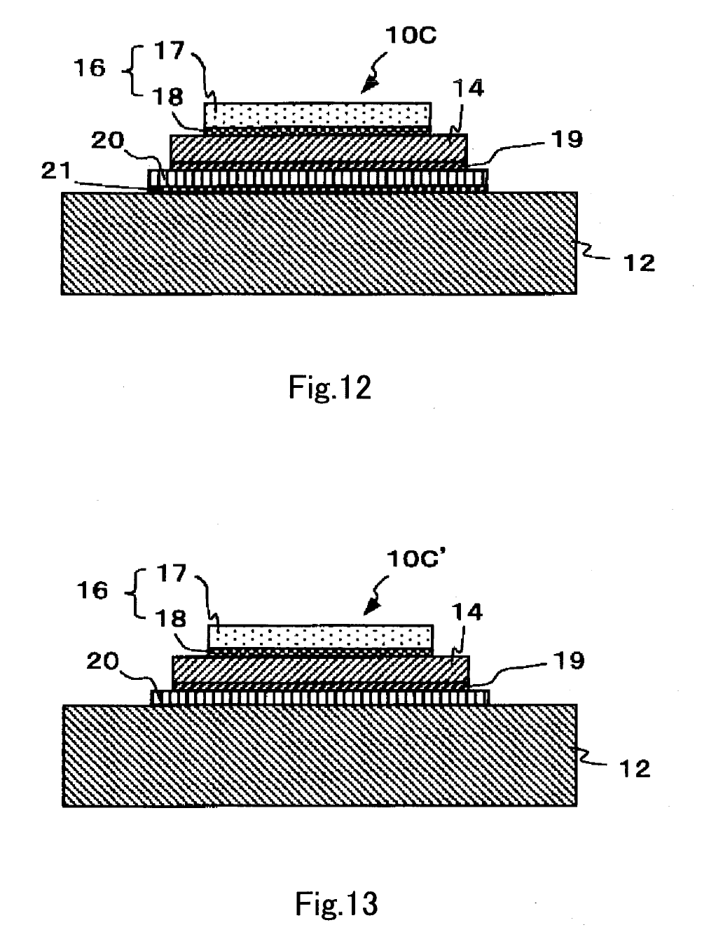

FIG. 12 is a schematic cross-sectional view showing the third embodiment of the card. As shown in FIG. 12, a card 10C of the present embodiment in the card 10A shown in FIG. 2 has a structure that a primary layer 20 and a primary adhesive layer 21 are added between the intermediate adhesive layer 19 and the substrate 12.

When the water growth layer 14 and the intermediate adhesive layer 19 are previously formed on the primary layer 20, the water growth layer 14 can be easily provided on the substrate 12 only by adhering the primary layer 20 to the substrate 12 without directly coating the substrate 12 with these layers. Therefore, the card 10C formed with these layers can be manufactured even in a place without coating facilities of the intermediate adhesive layer and the water growth layer.

As the primary layer 20, a resin film which is not deformed by forming the intermediate adhesive layer and the water growth layer may be used. The resin film with the same material as that of the substrate may be used.

As the primary adhesive layer 21, various adhesive, a double-sided tape or the like can be used. In the case where pressure sensitive adhesive is sued, the primary layer can be adhered to the substrate only by pressurizing, thereby simplifying the structure of the card manufacturing apparatus. The pressure sensitive adhesive includes acrylic pressure sensitive adhesive, synthetic rubber pressure sensitive adhesive, block copolymer pressure sensitive adhesive, polyolefin pressure sensitive adhesive, silicone pressure sensitive adhesive and the like. It is preferable that fine particle filler showing incompatibility with an adhesive base is compounded with a pressure sensitive non-peeling adhesive base which is difficulty peeled after it is once adhered.

FIG. 13 is a schematic cross-sectioal view showing a modified example of the card 10C. As shown in FIG. 13, the card 10C′ has the same structure as that of the card 10C shown in FIG. 12 except that the primary adhesive layer 21 is omitted. A resin material having a property for heat-sealing with the substrate, for example, is used as the primary layer 20, so that the primary layer 20 can be fixed directly onto the substrate 12 by heating and fusing the primary layer 20.

In the present embodiment, similarly to the card 10B of the second embodiment, a label layer, surface layer of which adheres directly to the water growth layer may be adopted instead of the adhesive label 16.

<Manufacturing Example of Card>

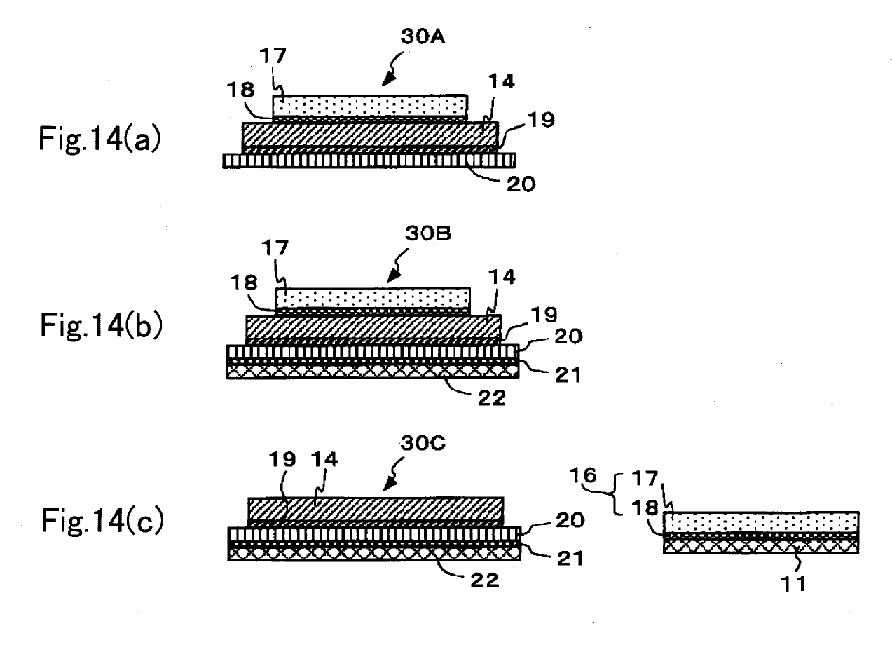

FIGS. 14(a) through 14(c) show examples of a card manufacturing label for manufacturing the card of the third embodiment. FIG. 14(a) is an example of the card manufacturing label having a structure in which the intermediate adhesive layer 19, the water growth layer 14, the cohesive layer 18 and the surface printing layer 17 are provided in this order on the primary layer 20. In a label 30A, the primary layer 20 does not have adhesion itself, and thus the primary layer 20 is fixed to the substrate by using an adhesive, a double-sided adhesive tape or the like. In another manner, a material or the like having a property for heat-sealing with the substrate is used as the primary layer 20, and it is heated so that the primary layer 20 is fixed to the substrate.

FIG. 14(b) shows an example of the card manufacturing label in which the primary adhesive layer 21 is provide on a back side of the primary layer 20 and the releasing sheet 22 is provided so as to cover the primary adhesive layer 21 in addition to the structure of FIG. 14(a). In a label 30B, the releasing sheet 22 is peeled and the primary adhesive layer 21 is laminate to the substrate 12, so that the primary layer 20 can be fixed to the substrate easily.

In FIGS. 14(a) and 14(b), as shown in FIG. 14(c), the label 16 composed of the surface layer 17 and the adhesive layer 18 is used separately, and after the label manufacturing label 30C including the primary layer 20 and the water growth layer 14 is fixed to the substrate 12, the separated label 16 may be laminated onto the water growth layer 14.

<Reproducing Example of Card>

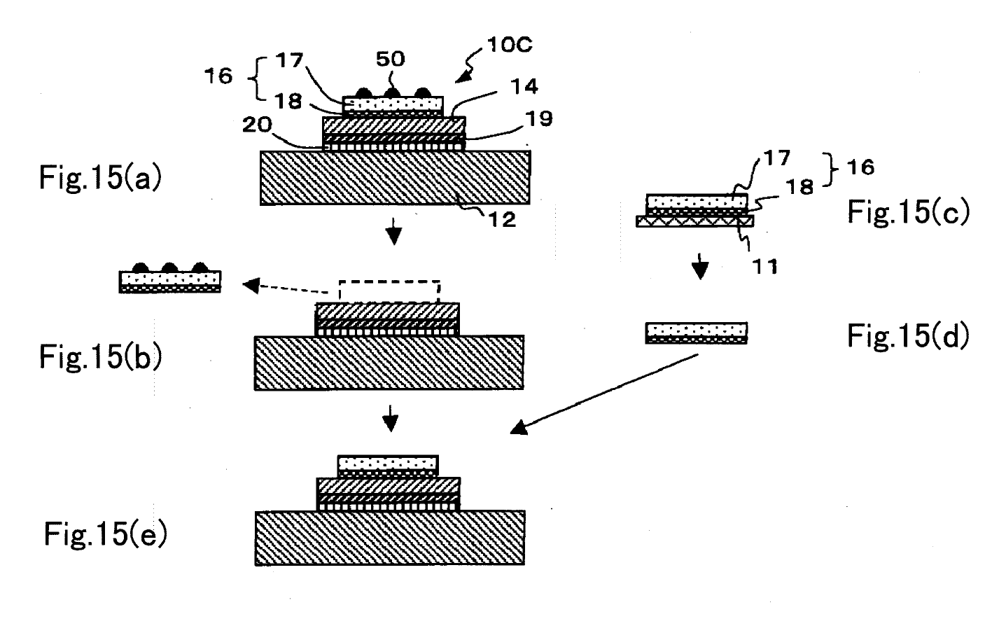

FIGS. 15(a) through 15(e) are step diagrams showing one example of the card reproducing steps of the third embodiment. As shown in FIGS. 15(a) through 15(e), firstly a liquid such as water is supplied to the surface layer 17 of the used card 10C in which characters (recording material is designated by reference number 50) or the like are written on the adhesive label 16, so that the water growth layer 14 swells. As a result the adhesion between the cohesive layer 18 of the character written adhesive label 16 and the water growth layer 14 is weakened, and the adhesive label 16 is peeled (see FIGS. 15(a) and 15(b)).

After the adhesive label 16 is peeled, the water growth layer 14 as well as the primary layer 20 remains on the substrate 12. Therefore, it is not necessary to newly provide the primary layer 20 and the water growth layer 14 every time of card reproduction. As shown in FIGS. 15(c) and 15(d), the releasing sheet 11 is peeled from the adhesive label 16 with the releasing sheet and the cohesive layer 18 is laminated onto the water growth layer 14 so as to be opposed to each other, so that the reproduction of the card 10C is completed (see FIG. 15(e)).

In such a manner, the water growth layer as well as the primary layer is adhered to the substrate only at the time of initially manufacturing of the card and only the adhesive label is provided at the time of reproduction, so that there is not a disadvantage that the signature section becomes thicker if the reproduction is repeated.

### EXAMPLE OF CARD MANUFACTURING APPARATUS

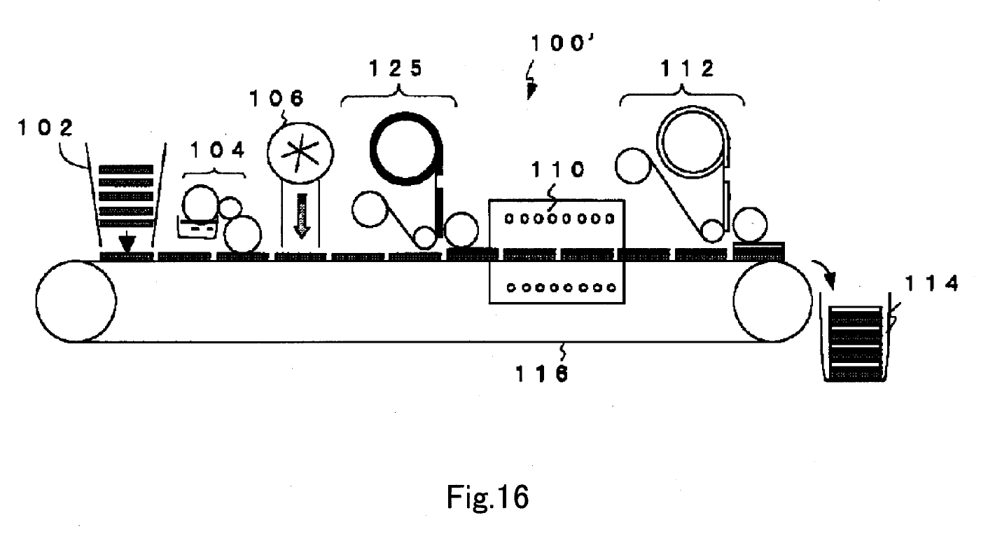

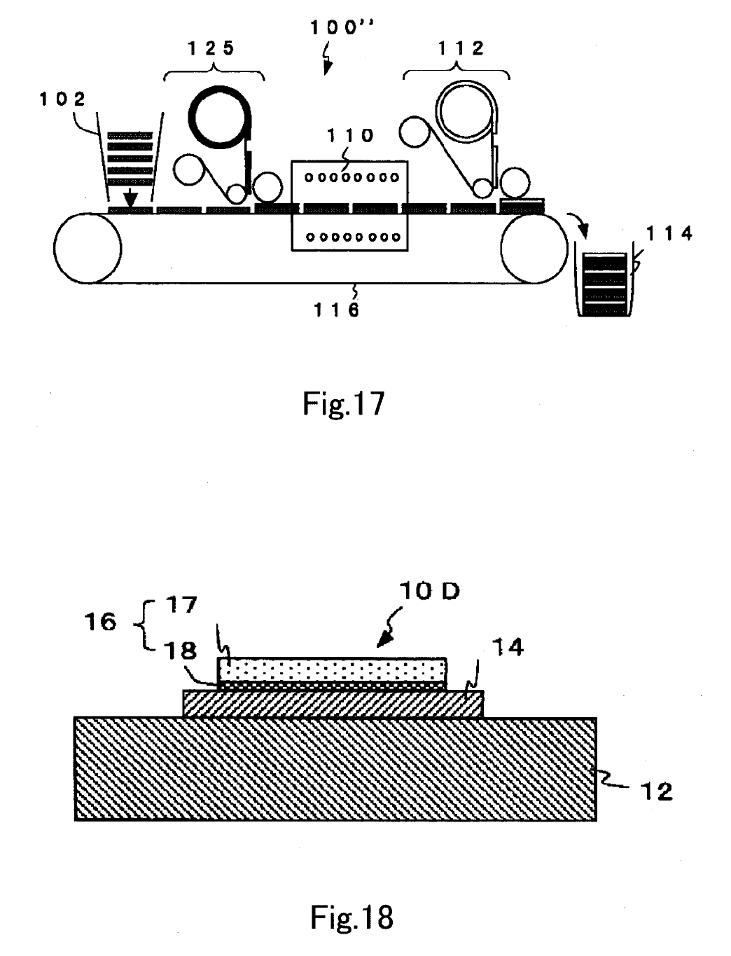

FIG. 16 is a structural diagram showing one example of the card manufacturing apparatus for manufacturing the card of the third embodiment. As shown in FIG. 16, the card manufacturing apparatus 100′ includes a card hopper 102, a primary adhesive layer coating device 104 such as a roll coater, a dryer 106, a first applicator 125, a heating device 110, a second applicator 112, a card housing container 114 and a transport belt 116. The card hopper 102 houses unused IC cards without labels and water growth layers. The dryer 106 dries a coated primary adhesive layer. The first applicator 125 laminates a card manufacturing label (here, above-explained label 30A) including water growth layer and primary layer. The heating device 110 heats a card so as to fix the primary layer. The second applicator 112 laminates an adhesive label onto a water growth layer of a card. The card housing container 114 houses cards to which labels are laminated. The transport belt 116 transports cards.

In the manufacturing apparatus 100′, firstly an IC card supplied from the card hopper 102 is placed on the transport belt 116. The IC card is coated with a primary adhesive layer material into a band shape by the coating device 104, and it is dried wit hot air by the dryer 106.

Next, the card manufacturing label including the water growth layer and the primary layer is laminated on the primary adhesive layer by the first applicator 125, and the primary adhesive layer is heated to be cured by the heating device 110 so that the primary layer is adhered to the substrate.

Finally, a releasing sheet is peeled from an adhesive label roll in which the releasing sheet is laminated on the adhesive surface by the second applicator 112, and the adhesive label is laminated on the water growth layer. In such a manner, the card provided with the label is completed so as to be housed in the housing section 114.

In the case where a pressure sensitive adhesive is used as the primary adhesive layer, the heating device 110 is not necessary. Moreover, in the case where the above-explained card manufacturing label 30B is used, the coating device 104 and the dryer 106 for the primary adhesive layer ar not necessary.

FIG. 17 is a modified example of the card manufacturing apparatus for manufacturing the card of the third embodiment. As shown in FIG. 17, the card manufacturing apparatus 100″ includes a card hopper 102, a first applicator 125, a heat roller 126, a second applicator 112, a card housing holder 114, and a transport belt 116. The card hopper 102 houses IC cards without labels and water growth layers. The first applicator 125 places a card manufacturing label (here, the aforementioned label 30A) including a water growth layer and a primary layer on a card. The heat roller 126 heats to fix a label on a card. The second applicator 112 laminates an adhesive labels on a water growth layer of a card. The card housing container 114 houses manufactured cards. The transport belt 116 transports cards.

In the manufacturing apparatus 100″, firstly an IC card supplied from the card hopper 102 is placed on the transport belt 116. The first applicator 125 laminates the label including the water growth layer and the primary layer on the primary adhesive layer, and the heat roller 126 fuses the primary layer so as to thermo compression-bond it with the substrate.

Finally, a releasing sheet is peeled from an adhesive label roll in which the releasing sheet is laminated on the adhesive surface by the second applicator 112, and the adhesive label is laminated on the water growth layer. In such a manner, the card provided with the label is completed so as to be housed in the housing section 114.

<Fourth Embodiment of Card>

FIG. 18 is a schematic cross-sectional view showing a fourth embodiment of the card. As mentioned above, in the first embodiment, in the case where a card is reproduction at a number of times which exceeds the durability of its water growth layer, there is a fear that the peeling of the adhesive label is defective. If so, in the case where the durability of the IC card itself is very high, this case is uneconomical. In order to avoid this, in the present embodiment, the adhesive label is peeled together with the water growth layer, the card is coated with a new water growth layer at the time of reproduction.

The card 10D of the present embodiment has a structure that the intermediate adhesive layer 19 for fixing the water growth layer 14 onto the substrate 12 is omitted from the first embodiment. With this structure, the water growth layer 14 is swelled by supplying water to the adhesive label, so that the water growth layer 14 is easily peeled from the substrate. Even in the case where the intermediate adhesive layer 19 is omitted, the water growth layer 14 has adhesion of a certain extent, the card is allowable in actual use.

However, it is necessary to provide a water growth layer onto the substrate every time of reproduction, so that the reproducing steps become more complicated than the first through third embodiments.

<Card Manufacturing/Reproducing Apparatus>

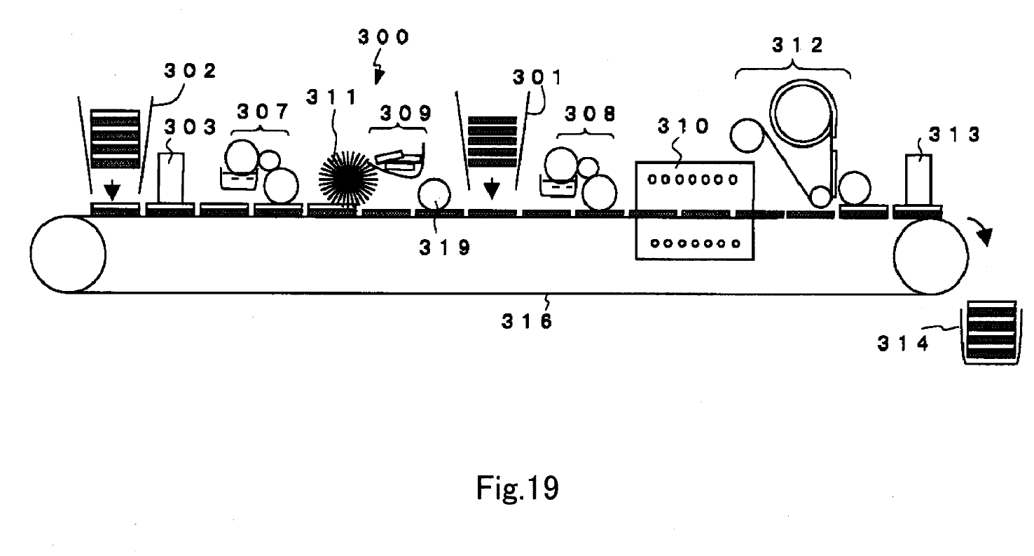

FIG. 19 is a structural diagram showing one example of the card manufacturing/reproducing apparatus. As show in FIG. 19, the card manufacturing/reproducing apparatus 300 includes a first hopper 302, a first reader/writer 303, a liquid supply device 307, a peeling member 331, a liquid absorbing member 319, a second hopper 301, a water growth layer coating device 308 such as a roll coater, a heating device 310, a label applicator 312, a second reader/writer 313, a card housing container 314 and a transport belt 316. The first hopper 302 houses used cards. The first reader/writer 303 deletes stored data of an IC card. The liquid supply device 307 supplies a liquid to a card. The peeling member 311 peels a label from a card. The liquid absorbing member 319 removes a liquid adhered to a card. The second hopper 301 houses IC cards unprovided with adhesive labels and water growth layers. The heating device 310 heats to cure a coated water growth layer material. The label applicator 312 laminates an adhesive label onto a water growth layer of a card. The second reader/writer 313 writes data into an IC card. The card housing container 314 houses reproduced cards. The transport belt 316 transports cards.

In the card manufacturing/reproducing apparatus 300, cards are carried in from a plurality of card carry-in paths. One of them is a carry-in path for a used IC card from the first hopper 302, and the other is a carry-in path for an IC card without a label and a water growth layer from the second hopper 301. A card is supplied from a middle of the latter card carry-in path.

As for a used IC card, which is supplied from the first hopper 302 and is placed on the transport belt 316, firstly, a first communication unit 303 deletes stored data of an IC chip, if necessary. Next, water is supplied from the liquid supply device 307 to an adhesive label, and water is infiltrate into a water growth layer so that the water growth layer is swelled. As a result, the adhesive label is in the easily peeling state. A mechanical force is applied to the adhesive label by the peeling member 311 such as a brush or a blade, so that the adhesive label is peeled from the water growth layer. In the case where an IC card has water resistance, the entire card may be soaked in water. In this case, the mechanical force for peeling is not necessary as long as the adhesive label is naturally peeled by soaking the card in water for predetermined time. After the adhesive label is peeled, moisture remaining on the water growth layer is wiped away by the sponge member 319. If necessary, the card may be simply rinsed with water before wiping-away. The card may be dried with hot air, if necessary.

A new IC card is supplied from the second hopper 301 at that point. The IC card, which is supplied from the second hopper 301 or undergoes the label peeling process so as not to have an adhesive label and a water growth layer, is coated with a water growth layer material into a band shape by the coating device 308, and the material is heated to be cured by the heating device 310 so that the water growth layer is formed. At this time, an intermediate adhesive layer is not provided.

Further, the label applicator 312 peels a releasing sheet from an adhesive label roll in which the releasing sheet is laminated to an adhesive surface so as to laminate the adhesive label onto the water growth layer.

Thereafter, the second communication device 313 records data into an IC chip of the IC card, if necessary. If the storage capacity is enough, a number of reproduction times may be stored as data. When a number of reproduction times is stored, a judgment can be made as to whether a number of reproduction times exceeds a specified value at the next reproduction. When a number of reproduction times reaches the specified value, the card can be previously stopped to be reproduced, and thus there is no fear that a defective card is mixed.

In such a manner, the card provided with new adhesive label is manufactured or reproduced so as to be housed in the housing section 314.

<Another Embodiment>

The above embodiments exemplified the IC card as the substrate of information holding medium to be reproduced, but magnetic cards such as a magnetic stripe card and an entire magnetic surface card, optical cards such as a read-only optical card and a rewriting optical card, a rewriting card having a thermosensitive recording layer, a general card such as a plastic card without a recording section and a rewriting display section may be used as the substrate. Moreover, besides cards, various tags such as IC tag (ID attached to luggage at the time of boarding airplane), memory media such as CD, MD and DVD, a returnable case for transportation, chemical or medical bottles or containers are used as the substrate, the present invention can be applied to the peeling of an adhesive label which is laminated onto the substrate for discriminating and display or the like of stored contents and housed objects. Moreover, the printing on the label layer may be carried out not only by recording using writing instruments but also by printing on an adhesive label with a releasing sheet using an an image forming apparatus such as a printer or a copying machine and the adhesive label may be laminated onto a water growth layer.

### Experimental Example 1

A part of a noncontact type IC card covered with PETG containing an IC chip and an antenna coil was covered with a raw material solution made of urethan resin and melamine crosslinker into a band shape with width of 2.5 cm and length of 7 cm by a roll coater having width of 2.5 cm, and it was dried at about 125° C. for 40 seconds so that an intermediate layer of 2 μm was applied to be formed.

18.75 parts by weight of glycerol polyglycidyl ether and melamin-formaldehyde resin were added as crosslinkers to a main component of 100 parts by weight of polyacrylic acid, so that a raw material solution containing 3.75 parts by weight of additive (sodium hydroxide), 0.625 parts by weight of fine particles (silica) and 5 parts by weight of surface active agent was prepared. The intermediate adhesive layer was coated with the raw material solution by a roll coater having width of 20 cm so as to be overlapped with each other, and after it was dried at about 120° C. for 30 seconds, it was heated to about 150° C. and was cured for about 15 seconds so that a water growth layer with thickness of 6 μm was formed.

Next, the following adhesive sticker, adhesive label adhesive tape and correction fluid on the market were used as an adhesive label and were cut into the same width and length as those of the water growth layer, and they were laminated or applied and dried so as to be adhered to the water growth layer. As a result, reproducible six kinds of cards were manufactured. As the adhesive label, the followings were used: (1) MY TACK LABEL ML-7 made by NICHIBAN Co., Ltd.,: (2) INK-JET PHOTO GLOSSY LABEL C99318 made by AVERY DENNISON MAXELL K.K.; (3) TACK INDEX (PERMANENT TYPE)) TA-21R made by KOKUYO Co., Ltd.: (4)FLOPPY DISK LABEL made by Sony Corporation; (5) TRANSPARENT BOTH-SIDED TAPE TP-694 made by CEMEDINE Co., Ltd.; and (6) Correction fluid (product name: TW-45) made by KOKUYO Co., Ltd.

It is difficult to easily remove the label portions of the cards manufactured in such a manner, and thus it was confirmed that they are allowable for a practical use. Moreover, characters or symbols could be written on the label portions by a pencil, a ball-point pen, a felt pen, a magic marker and the like. In any cases, 2 cc of water with 30° C. was absorbed by a dropper and was dropped onto the printing portions, and after it was left still for 180 seconds, the adhesive labels were peeled from their corner portions by fingers. As a result, the adhesive labels (provided with cohesive layers, together with them) could be very easily peeled from the water growth layers.

After the adhesive labels were peeled, a sponge was slightly put on the surface of the water growth layers so that moisture was absorbed, and the water growth layers were dried at 80° C. for 180 seconds. Thereafter, new adhesive labels were provided onto the water growth layers, so that cards with blank printing portions could be reproduced. The adhesive labels could be again peeled by supplying water to the cards under the similar condition to the above one. The same operation was repeated ten times, and the peeling and reproduction could be carried out satisfactorily.

In addition, when width and length of adhesive labels are made to be smaller than those of the water growth layers and the same operation was performed, the surface layers could be peeled, and thus it was confirmed that the cards can be used repeatedly.

Further, plastic sheets made of polyvinyl chloride (PVC), polyester, polypropylene or polyvinyl acetate, which were generally used as a material of cards, were used as the substrate, and the experiment was conducted on them in the similar procedure to the above one. In any cases, similarly to the above, it was confirmed that the peeling and reproduction of the labels can be carried out satisfactorily.

### Experimental Example 2

PET with thickness of 25 μm as a primary layer and acrylic pressure sensitive adhesive as a primary adhesive layer were used, so that a card was manufactured in the similar manner to the embodiment 1 except for the structure sown in FIG. 12. It was difficult to easily peel a printing portion of the card manufactured in such a manner, and thus it was confirmed that the card is allowable for practical used. Moreover, characters or symbols could be written on the label portion by a pencil, a ball-point pen, a felt pen, a magic marker and the like. When water was supplied to the card similarly to the embodiment 1 and an adhesive label was peeled by fingers from its corner portion, the adhesive label (if provided with a cohesive layer, together with it) could be peeled from a water growth layer extremely easily.

After the adhesive label was peeled, the water growth layer was dried similarly to the embodiment 1, and a new adhesive label was provided onto the water growth layer, so that the card could be reproduced. Although the same operation was repeated ten times, the peeling and reproduction of the card could be carried out satisfactorily.

### Experimental Example 3

A card without an intermediate adhesive layer was manufactured similarly to the embodiment 1 except for the structure shown in FIG. 18. It was difficult to easily peel a printing portion of the card manufactured in such a manner, and thus it was confirmed that the card is allowable for practical use. Moreover, characters or symbols could be written on the label portion by a pencil, a ball-point pen, a felt pen, a magic marker and the like. 2 cc of water at 30° C. was absorbed by a dropper and was dropped on the printing section, and the printing section was left still for 60 seconds. Thereafter, when the label was peeled by fingers from its corner portion, the adhesive label as well as the water growth layer could be peeled from the substrate.

<Effect of the Invention>

According to the invention, when an information holding medium is used, a printing label layer is fixed onto a substrate by a practically sufficient adhesion, and when the information holding medium is reproduced, the printing label layer can be easily removed, so that the information holding medium can be reproduced easily. Therefore, wastage of resources can be prevented, and environmental disruption and environmental pollution can be suppressed.

Particularly in the case where the water growth layer remains on the substrate, it is not necessary to provide a new water growth layer every time of reproduction, the card can be reproduced by the simple process. In the case where the water growth layer is removed from the substrate at the time of swelling, a number of reproduction times of the information holding medium is not limited by the durability of the water growth layer.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A reproducible information holding medium comprising:
a substrate;
a water growth layer provided on the substrate; and
a printing label layer provided on the water growth layer and adhering thereto,
wherein the information holding medium carries out at least printing on the printing label layer so as to hold information.

2. A reproducible information holding medium according to claim 1,
wherein when water or aqueous solvent is supplied to the water growth layer so that the water growth layer is swelled, the printing label layer is peeled from the information holding medium, and the water growth layer remains on the substrate.

3. A reproducible information holding medium according to claim 2 further comprising:
an intermediate adhesive layer for fixing the water growth layer to the substrate being provided between the water growth layer and the substrate.

4. A reproducible information holding medium according to claim 1,
wherein when water or aqueous solvent is supplied to the water growth layer so that the water growth layer is swelled, the printing label layer and the water growth layer are peeled from the substrate.

5. A reproducible information holding medium according to claim 4,
wherein the water growth layer is provided directly on the substrate.

6. A reproducible information holding medium according to claim 1,
wherein the substrate includes a storage circuit.

7. A reproducible information holding medium according to claim 1,
wherein the printing label layer has a surface layer where printing is carried out and an cohesive layer provided on a back surface of the surface layer and has adhesion for making the peeling difficult when the cohesive layer is laminated directly to the substrate without the water growth layer.

8. A reproducible information holding medium according to claim 7,
wherein the surface layer has water resistance.

9. A reproducible information holding medium according to claim 1,
wherein the printing label layer is formed in such a manner that after a coating compound is applied directly to the surface of the water growth layer, it is dried.

10. A reproducible information holding medium according to claim 1,
wherein the printing label layer has a thickness of 25 μm to 50 μm.

11. A reproducible information holding medium according to claim 1,
wherein a size of the water growth layer is the same as or larger than a size of the printing label layer, and the printing label layer is superposed on the water growth layer.

12. A reproducible information holding medium according to claim 1,
wherein the water growth layer is made of water growth resin obtained by crosslinking water-soluble resin.

13. A reproducible information holding medium according to claim 1 further comprising:
a primary layer,
wherein the water growth layer is formed on the primary layer, and the primary layer may be allowed to adhere to the substrate.

14. A reproducing method for reproducing a reproducible information holding medium having a substrate, a water growth layer provided on the substrate, and a printing label layer provided on the water growth layer and adhering thereto, the method comprising the steps of:
supplying water or aqueous solvent to the water growth layer;
removing the printing label layer; and
adhering a new printing label layer to the water growth layer remaining on the substrate.

15. A reproducing method for reproducing a reproducible information holding medium according to claim 14,
wherein the reproducible information holding medium includes a storage circuit and recording information being stored in the storage circuit is updated.

16. A reproducing method for reproducing a reproducible information holding medium having a substrate, a water growth layer provided on the substrate, and a printing label layer provided on the water growth layer and adhering thereto, the method comprising the steps of:
supplying water or aqueous solvent to the water growth layer;
removing the printing label layer and the water growth layer from the substrate; and
forming a new water growth layer on the substrate and adheres a new printing label layer to the new water growth layer.

17. A reproducing method for reproducing a reproducible information holding medium according to claim 16,
wherein the reproducible information holding medium includes a storage circuit and recording information being stored in the storage circuit is updated.

18. A reproducing apparatus for reproducing a reproducible information holding medium having a substrate, a water growth layer provided on the substrate, and a printing label layer provided on the water growth layer and adhering thereto, the reproducing apparatus comprising:
liquid supplier for supplying water or aqueous solvent so as to swell the water growth layer;
label remover for removing the printing label layer from the swelled water growth layer;
moisture remover for removing moisture on surface and/or inside of the water growth layer; and
label forming device for forming a new printing label layer on the water growth layer form which the printing label layer has been removed.

19. A reproducing apparatus for reproducing a reproducible information holding medium having a substrate, a water growth layer provided on the substrate, and a printing label layer provided on the water growth layer and adhering thereto, the reproducing apparatus comprising:
liquid supplier for supplying water or aqueous solvent so as to swell the water growth layer;
remover for removing the swelled water growth layer and the printing label layer from the substrate,
water growth layer forming device for forming a new water growth layer on the substrate; and
printing label layer forming device for forming a new printing label layer on the new water growth layer.

20. A reproducing apparatus according to claim 19 further comprising:
first insertion port into which a used information holding medium is inserted; and
second insertion port into which the information holding medium without the water growth layer and the printing label layer is inserted.
